(19) United States
(12) Patent Application Publication
(10) Pub. No.: US 2013/0059216 A1
(43) Pub. Date: Mar. 7, 2013

(54) FUEL CELL SYSTEM

(71) Applicants: Hyun KIM, Yongin-si (KR); Young-Seung NA, Yongin-si (KR); Jung-Kurn PARK, Yongin-si (KR); Dong-Hyun KIM, Yongin-si (KR); Dong-Rak KIM, Yongin-si (KR); Jong-Rock CHOI, Yongin-si (KR)

(72) Inventors: Hyun KIM, Yongin-si (KR); Young-Seung NA, Yongin-si (KR); Jung-Kurn PARK, Yongin-si (KR); Dong-Hyun KIM, Yongin-si (KR); Dong-Rak KIM, Yongin-si (KR); Jong-Rock CHOI, Yongin-si (KR)

(73) Assignee: SAMSUNG SDI CO., LTD., Yongin-si (KR)

(21) Appl. No.: 13/324,820

(22) Filed: Dec. 13, 2011

(30) Foreign Application Priority Data
Sep. 5, 2011 (KR) 10-2011-0089792

(51) Int. Cl. H01M 8/06

(52) U.S. Cl. 429/414

(57) ABSTRACT

A fuel cell system is disclosed. The fuel cell system may include a fuel cell stack configured for generating electrical energy by a reaction of an oxidant and a fuel, a recovery unit including a first gas liquid separator configured for separating a by-product discharged by the fuel cell stack into a first gas and a first liquid, a first heat exchanger configured for cooling the first gas supplied by the first gas liquid separator, and a second gas liquid separator configured for separating a by-product supplied by the first heat exchanger into a second gas and a second liquid, and a remover unit fluidly connected to the second gas liquid separator and configured for removing the second gas from the recovery unit.

### CROSS-REFERENCE TO RELATED APPLICATIONS

This application claims priority to and the benefit of Korean Patent Application No. 10-2011-0089792 filed in the Korean Intellectual Property Office on Sep. 5, 2011, the entire contents of which are incorporated herein by reference.

### BACKGROUND

1. Field

The described technology relates generally to a fuel cell system.

2. Description of the Related Technology

It is important for a fuel cell system to not be negatively influenced by a by-product that is produced while electricity is generated. For example, when the electricity is generated in the fuel cell system, unreacted fuel containing a dioxide is discharged from the anode of the fuel cell stack and unreacted air is discharged from the cathode. The gas liquid mixture output by the fuel cell stack is separated into gas and liquid so that the gas may be output to the outside of the system and the liquid may be supplied to the stack. To achieve this purpose, a gas liquid separator and a heat exchanger are included in the fuel cell system. However, when the mixture has passed through the gas liquid separator, the gas output to the outside of the system may contain moisture. When the moisture is discharged out of the system as described, moisture may leak out of or the moisture may cause electrical damage to the system and/or may cause a problem with other devices.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

The described technology has been made in an effort to provide a fuel cell system for controlling discharge of moisture to the outside of the system.

In one aspect, a fuel cell system includes, for example, a fuel cell stack configured for generating electrical energy by a reaction of an oxidant and a fuel, a recovery unit in fluid communication with the fuel cell stack, the recovery unit including a first gas liquid separator configured for separating a by-product discharged by the fuel cell stack into a first gas and a first liquid, a first heat exchanger configured for cooling the first gas supplied by the first gas liquid separator, and a second gas liquid separator configured for separating a by-product supplied by the first heat exchanger into a second gas and a second liquid, and a remover unit fluidly connected to the second gas liquid separator and configured for removing the second gas from the recovery unit.

In some embodiments, the remover unit includes, for example, a discharge pipe fluidly connected to the first heat exchanger and the second gas liquid separator, and a nozzle installed at an end of the discharge pipe and configured for spraying spray the second gas to the first heat exchanger. In some embodiments, the first heat exchanger includes a flow path through which the first gas passes. In some embodiments, the nozzle is disposed toward a surface of the flow path. In some embodiments, a surface of the flow path is formed from a hydrophobic or water repellent surface process. In some embodiments, the flow path includes a film formed on the surface thereof, which film is formed of a hydrophobic material. In some embodiments, the recovery unit further includes, for example, a mixer configured for receiving the first liquid from the first gas liquid separator, mixing the first liquid with a thickened fuel, and supplying the mixed fuel to the fuel cell stack, and a second heat exchanger disposed between and in fluid communication with the mixer and the fuel cell stack, the second heat exchanger configured for lowering the temperature of the mixed fuel.

In some embodiments, the remover unit includes a discharge pipe fluidly connected to the second heat exchanger and the second gas liquid separator, and a nozzle installed at an end of the discharge pipe and configured for spraying the second gas to the second heat exchanger. In some embodiments, the discharge pipe is fluidly connected to the first heat exchanger. In some embodiments, the second heat exchanger includes a flow path through which the mixed fuel passes. In some embodiments, the nozzle is disposed toward a surface of the flow path. In some embodiments, the surface of the flow path is formed from a hydrophobic or water repellent surface process. In some embodiments, a film including a hydrophobic material is formed on the surface of the flow path. In some embodiments, the temperature of the second gas is lower than the temperature of the recovery unit.

In some embodiments, moisture is prevented from being discharged outside the fuel cell system thereby controlling application of a negative influence on the system by moisture. Further, since the moisture is removed by using the heat exchanger, the temperature of the heat exchanger is controllable by vaporization of the moisture, and system performance can be improved by improvement of heat exchange efficiency of the heat exchanger.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 shows a block diagram of a fuel cell system according to an exemplary embodiment.

FIG. 2 shows a schematic diagram of a fuel cell system according to an exemplary embodiment.

FIG. 3 shows a partial exploded perspective view of a fuel cell stack shown in FIG. 2.

FIG. 4 shows a schematic diagram of a heat exchanger according to an exemplary embodiment.

FIG. 5 shows an enlarged view of a part I of FIG. 4.

### DETAILED DESCRIPTION OF CERTAIN INVENTIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, embodiments of the disclosure will be described with reference to the attached drawings. If there is no particular definition or mention, terms that indicate directions used to describe the disclosure are based on the state shown in the drawings. Further, the same reference numerals indicate the same members in the embodiments.

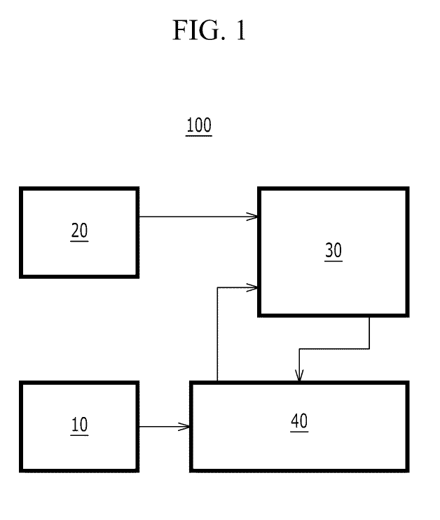

FIG. 1 shows a block diagram of a fuel cell system according to an exemplary embodiment. Referring to FIG. 1, the fuel cell system 100 can adopt a direct methanol fuel cell method for generating electrical energy through a direct reaction of methanol and oxygen. However, the present disclosure is not restricted thereto, and the fuel cell system according to the present exemplary embodiment can be configured to use a direct oxidation fuel cell for controlling the liquid or gas fuel including hydrogen, ethanol, LPG, LNG, gasoline, or butane gas to react with oxygen. Further, the fuel cell system can be configured by using a polymer electrode membrane fuel cell (PEMFC) method for reforming the fuel into reformed gas with hydrogen.

The fuel used for the fuel cell system 100 may include hydrocarbon-based liquid or gas fuel such as methanol, ethanol, natural gas, or LPG. Further, during operation of the system oxygen gas stored in an additional storage means or air can be used for the oxidant that reacts with the hydrogen in the fuel cell system 100. The fuel cell system 100 includes a fuel cell stack 30 configured for generating power using fuel and oxidant, a fuel supplier 10 configured for supplying fuel to the fuel cell stack 30, an oxidant supplier 20 configured for supplying oxidant configured for generating electricity to the fuel cell stack 30, and a recovery unit 40 configured for recovering unreacted fuel and oxidant discharged by the fuel cell stack 30 and configured for supplying the same to the fuel cell stack 30. The fuel supplier 10 and the oxidant supplier 20 are fluidly connected to the fuel cell stack 30, respectively. The oxidant supplier 20 is fluidly connected to the fuel cell stack 30, and the fuel supplier 10 is fluidly connected to the fuel cell stack 30 through the recovery unit 40. The recovery unit 40 may be configured to recover liquid from the unreacted oxidant and the unreacted fuel discharged by the fuel cell stack 30, mix them with the fuel, and supply the mixture to the fuel cell stack 30.

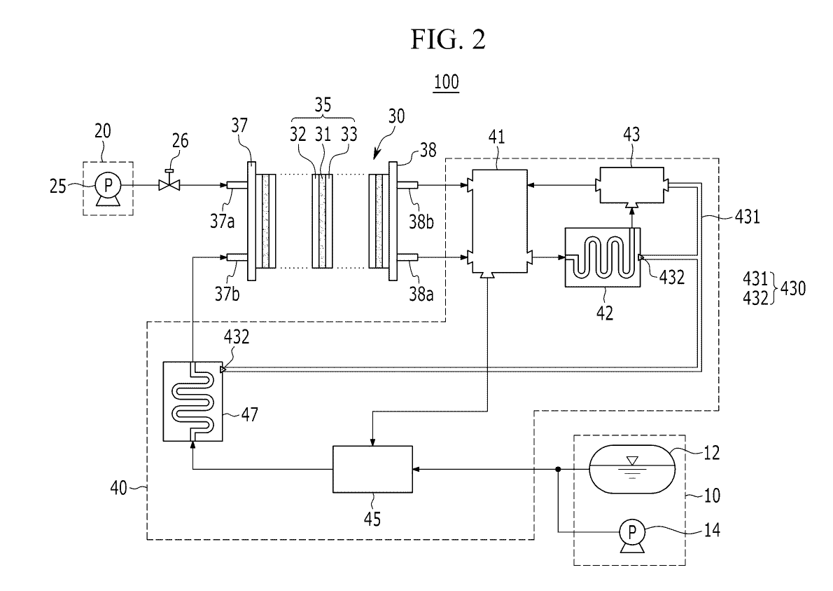

FIG. 2 shows a schematic diagram of a fuel cell system according to an exemplary embodiment. Referring to FIG. 2, the fuel supplier 10 includes a fuel tank 12 for storing liquid fuel and a fuel pump 14 fluidly connected to the fuel tank 12. During operation of the system the fuel pump 14 discharges the liquid fuel stored in the fuel tank 12 from the fuel tank 12 and supplies it to the fuel cell stack 30 by a predetermined pumping force. The fuel stored in the fuel tank 12 can be made of highly-concentrated methanol of substantially 100% MeOH. The oxidant supplier 20 is fluidly connected to the fuel cell stack 30, and it includes an oxidant pump 25 configured for inhaling external air with a predetermined pumping power and supplying it to the fuel cell stack 30. In this instance, a control valve 26 configured for controlling the supply of oxidant can be installed between and in fluid communication with the fuel cell stack 30 and the oxidant supplier 20.

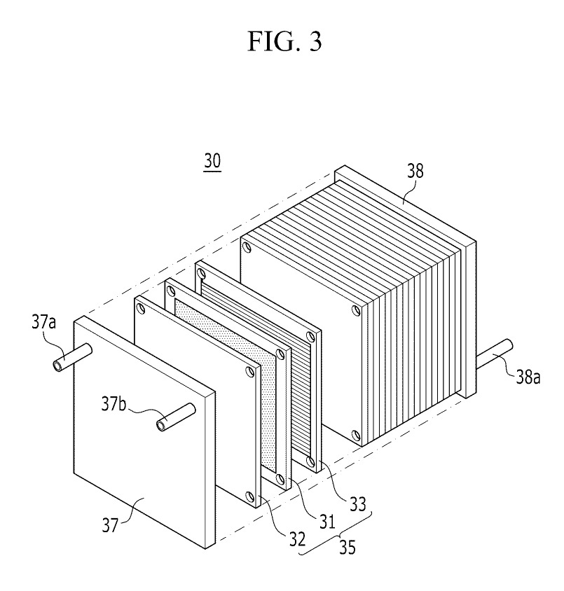

FIG. 3 shows a partial exploded perspective view of a fuel cell stack shown in FIG. 2. Referring to FIG. 2 and FIG. 3, the fuel cell stack 30 includes a plurality of electricity generators 35 configured for generating electrical energy by inducing an oxidation/reduction reaction of fuel and oxidant. Each electricity generator 35 represents a unit cell configured for generating electricity, which includes a membrane electrode assembly (MEA) 31 configured for oxidizing and reducing oxygen in the fuel and the oxidant, and separators (also called bipolar plates) 32 and 33 configured for supplying the fuel and the oxidant to the membrane electrode assembly 31.

The electricity generator 35 has a configuration in which the separators 32 and 33 are disposed on both sides of the membrane electrode assembly 31. The membrane electrode assembly 31 may include an electrolyte film disposed in the center, a cathode disposed on a first side of the electrolyte film, and an anode disposed on a second side of the electrolyte film.

The separators 32 and 33 are positioned in close proximity with respect to each other with the membrane electrode assembly 31 positioned therebetween to form a fuel path and an air path on respective sides of the membrane electrode assembly 31. In this instance, the fuel path is disposed on the side of the anode of the membrane electrode assembly 31 and the air path is disposed on the side of the cathode of the membrane electrode assembly 31. During operation of the fuel cell the electrolyte film is configured to move hydrogen ions generated by the anode to the cathode so that the hydrogen ions may combine with the oxygen of the cathode to generate water (for example, in an ion exchange.). Therefore, hydrogen is decomposed into electrons and hydrogen ions by an oxidation reaction at the anode. The hydrogen ions are moved to the cathode through the electrolyte film, and the electrons are not moved through the electrolyte film but are moved to the cathode of the neighboring membrane electrode assembly 31 through the separator 33, and in this instance, the current is generated because of the flow of the electrons. Also, moisture is generated through the reduction reaction of the moved hydrogen ions, the electrons, and the oxygen at the cathode.

The fuel cell stack 30 can be configured with a set of sequentially disposed electricity generators 35. End plates 37 and 38 for integrally fixing a plurality of electricity generators 35 and forming a stack 30 are installed to the outermost part of the set.

A first inlet 37a configured for supplying the oxidant to the fuel cell stack 30 and a second inlet 37b configured for supplying the fuel to the fuel cell stack 30 are formed on the end plate 37. Also, a first discharger 38a configured for discharging an unreacted oxidant including moisture generated by a combining reaction of hydrogen and oxygen at the cathode of the membrane electrode assembly 31 and a second discharger 38b configured for discharging unreacted fuel that remains after reaction at the anode of the membrane electrode assembly 31 are formed on the other end plate 38.

The recovery unit 40 is in fluid communication with the first discharger 38a and the second discharger 38b to receive the by-products from the fuel cell stack 30. The by-products include the unreacted oxidant and unreacted fuel including moisture. The recovery unit 40 includes two gas liquid separators 41 and 43, two heat exchangers 42 and 47, and a mixer 45 so as to increase the liquid recovery efficiency.

The first gas liquid separator 41 may be formed with a centrifugal or an electrokinetic pump. The first gas liquid separator 41 is directly and fluidly connected to the first discharger 38a and the second discharger 38b of the fuel cell stack 30. The first gas liquid separator 41 may be configured to mix the unreacted oxidant including moisture discharged by the first discharger 38a and the unreacted fuel discharged by the second discharger 38b. The first gas liquid separator 41 may be configured to separate the same into a first liquid and a first gas.

During operation, the first gas discharged by the first gas liquid separator 41 is provided to the first heat exchanger 42, and the separated first liquid moves to the mixer 45. The first heat exchanger 42 cools the first gas provided by the first gas liquid separator 41 to condense some of the first gas into a liquid. The unreacted fuel and the steam discharged by the fuel cell stack 30 have a high temperature, so when the first heat exchanger 42 reduces the gas temperature, a part of the gas can be condensed into liquid.

A mixture of the liquid and the gas condensed by the first heat exchanger 42 is provided to the second gas liquid separator 43. In a like manner of the first gas liquid separator 41, the second gas liquid separator 43 can be configured with a centrifugal or an electrokinetic pump.

The second gas liquid separator 43 is configured to separate the mixture provided by the first heat exchanger 42 into a second liquid and a second gas. During operation, the second liquid separated by the second gas liquid separator 43 is provided to the first gas liquid separator 41. The second liquid discharged by the second gas liquid separator 43 is provided to the first gas liquid separator 41 so the mixture of gas and liquid discharged by the fuel cell stack 30 undergoes the gas liquid separation process three times. Hence, the recovery unit 40 improves the liquid recovery efficiency.

The second gas separated by the second gas liquid separator 43 is removed from the recovery unit 40 by a remover unit 430. The remover unit 430 includes a discharge pipe 431 in fluid communication with the second gas liquid separator 43. The discharge pipe 431 sprays the second gas into the recovery unit 40. For example, the second gas separated from the second gas liquid separator 43 is sprayed into the first heat exchanger 42 and the second heat exchanger 47 of the recovery unit. The second gas in this instance includes a small amount of moisture that failed to condense into liquid. The second gas separated by the second gas liquid separator 43 is sprayed into the high-temperature first heat exchanger 42 and the second heat exchanger 47 so the moisture included in the second gas is vaporized by the heat generated by the first heat exchanger 42 or the second heat exchanger 47 and is then removed.

That is, since high-temperature liquid is input to the heat exchangers 42 and 47, the temperature is higher than the temperature of the second gas separated by the second gas liquid separator 43, and the moisture included in the second gas separated by the second gas liquid separator 43 is vaporized by the high temperature of the heat exchangers 42 and 47 and is then removed.

The remover unit 430 includes a nozzle 432 disposed at an end of the discharge pipe 431. The gas separated from the condensed liquid by the second gas liquid separator 43 is sprayed by the nozzle 432. The moisture included in the second gas is also sprayed by the nozzle 432, thereby vaporizing the moisture.

The second liquid discharged by the first gas liquid separator 41 is input to the mixer 45. The second liquid in this instance is the mixture of unreacted fuel and moisture. Also, the mixer 45 is fluidly connected to the fuel supplier 10. Therefore, the highly concentrated fuel (thickened fuel) provided by the fuel supplier 10 is input to the mixer 45, and the highly concentrated fuel is mixed with moisture by the mixer 45 and is then diluted into appropriately concentrated fuel. The fuel (mixed fuel) diluted by the mixer 45 is transmitted to the second heat exchanger 47, and the second heat exchanger 47 lowers the temperature of the mixed fuel and supplies it to the second inlet 37b of the fuel cell stack 30.

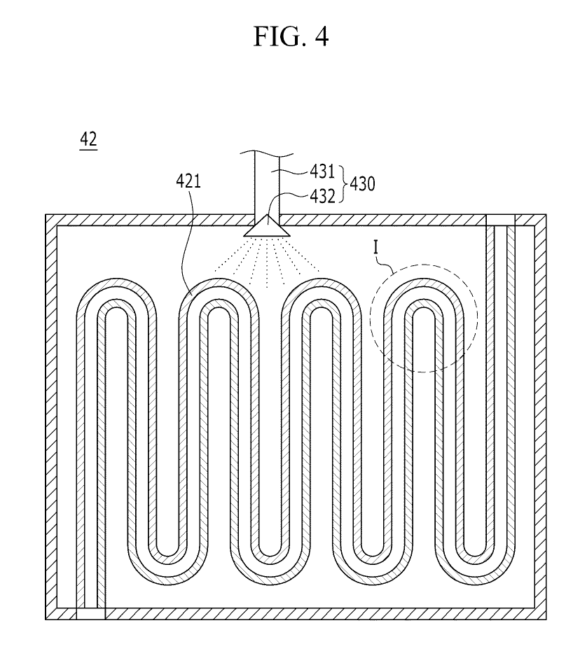

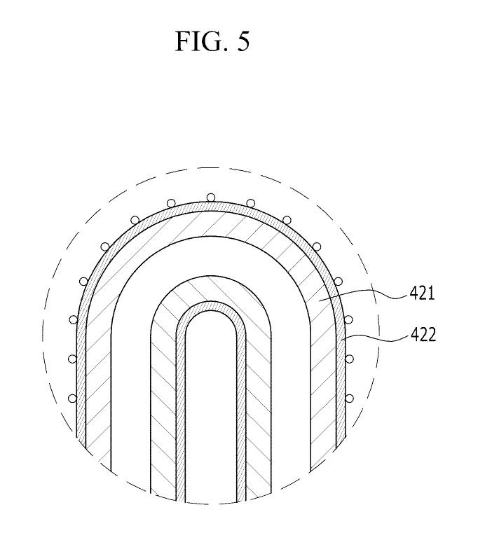

Referring to FIG. 4 and FIG. 5, a process for removing moisture from the inside of the heat exchangers 42 and 47 will now be described in detail. FIG. 4 and FIG. 5 show a configuration of the first heat exchanger 42, and the second heat exchanger 47 can also have an equivalent configuration. FIG. 4 shows a schematic diagram of a heat exchanger 42 according to an exemplary embodiment. The first heat exchanger 42 has a flow path 421 for supplying high-temperature gas, and it reduces the temperature of the flow path 421 to condense the steam included in the internal gas into moisture. Further, the first heat exchanger 42 can include a fan (not shown) configured for transmitting low-temperature air to the flow path 421 so as to lower the temperature of the flow path 421. The first heat exchanger 42 can be transformed into various shapes such as a plate or a cylinder without restrictions. The flow path 421 can be bent in a coil or zigzag shape so as to increase the flowing route of the high-temperature gas.

The nozzle 432 of the discharge pipe 431 fluidly connected to the second gas liquid separator 43 is disposed inside the heat exchangers 42 and 47 to spray the second gas discharged by the second gas liquid separator 43 to the insides of the heat exchangers 42 and 47, particularly the surface of the flow path 421. During operation, high-temperature gas is provided inside the flow path 421 so a surface temperature of the flow path 421 is greater than the temperature of the second gas, and the small amount of moisture included in the second gas is vaporized by the high surface temperature of the flow path 421 and is then removed.

FIG. 5 shows an enlarged view of a part I of FIG. 4. Referring to FIG. 5, the surface of the flow path 421 can be processed with a hydrophobic or water repellent film 422. During operation, the small amount of moisture sprayed to the surface of the flow path 421 can be prevented from permeating into the surface of the flow path 421 or being fogged up with steam by the hydrophobic or water repellent film 422, and the moisture stays as fine drops on the surface of the flow path 421 to accelerate vaporization of moisture. The hydrophobic or water repellent film 422 is not restricted to the above description, and for example, the surface of the flow path 421 can be coated with polytetrafluoroethylene (PTFE) or tetrafluoroethylene (FEP), a representative hydrophobic material, or it can be processed to be a hydrophobic or water repellent surface by performing a surface treatment such as sanding so as to make the surface rough.

The second gas has been described to be sprayed inside the heat exchangers 42 and 47 in the present exemplary embodiment, and without being restricted to this, it can be sprayed to other elements of the recovery unit 40 having a temperature that is higher than that of the second gas. In the fuel cell system 100 according to the present exemplary embodiment, the small amount of moisture that is not removed by the second gas liquid separator 43 can be removed without being discharged to the outside of the fuel cell system 100. Accordingly, electrical damage to the fuel cell system 100 caused by the moisture discharged to the outside or influence on other devices can be prevented.

In addition, when the moisture is vaporized in the heat exchangers 42 and 47, the heat of the heat exchangers is taken by the vaporization to lower the temperature so the heat exchange performance of the heat exchangers 42 and 47 is further improved, which thus improves fuel cell efficiency.

While this disclosure has been described in connection with what are presently considered to be practical exemplary embodiments, it will be appreciated by those skilled in the art that various modifications and changes may be made without departing from the scope of the present disclosure. It will also be appreciated by those of skill in the art that parts mixed with one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A fuel cell system, comprising:
a fuel cell stack configured for generating electrical energy by a reaction of an oxidant and a fuel;
a recovery unit in fluid communication with the fuel cell stack, the recovery unit including a first gas liquid separator configured for separating a by-product discharged by the fuel cell stack into a first gas and a first liquid, a first heat exchanger configured for cooling the first gas supplied by the first gas liquid separator, and a second gas liquid separator configured for separating a by-product supplied by the first heat exchanger into a second gas and a second liquid; and
a remover unit fluidly connected to the second gas liquid separator and configured for removing the second gas from the recovery unit.

2. The fuel cell system of claim 1, wherein the remover unit includes:
a discharge pipe fluidly connected to the first heat exchanger and the second gas liquid separator; and
a nozzle installed at an end of the discharge pipe and configured for spraying the second gas to the first heat exchanger.

3. The fuel cell system of claim 1, wherein the first heat exchanger includes a flow path through which the first gas passes.

4. The fuel cell system of claim 3, wherein the nozzle is disposed toward a surface of the flow path.

5. The fuel cell system of claim 3, wherein a surface of the flow path is formed from a hydrophobic or water repellent surface process.

6. The fuel cell system of claim 3, wherein the flow path includes a film formed on the surface thereof, the film formed of a hydrophobic material.

7. The fuel cell system of claim 1, wherein the recovery unit further comprises:
a mixer configured for receiving the first liquid from the first gas liquid separator, mixing the first liquid with a thickened fuel, and supplying the mixed fuel to the fuel cell stack; and
a second heat exchanger disposed between and in fluid communication with the mixer and the fuel cell stack, the second heat exchanger configured for lowering the temperature of the mixed fuel.

8. The fuel cell system of claim 7, wherein the remover unit includes:
a discharge pipe fluidly connected to the second heat exchanger and the second gas liquid separator; and
a nozzle installed at an end of the discharge pipe and configured for spraying the second gas to the second heat exchanger.

9. The fuel cell system of claim 8, wherein the discharge pipe is fluidly connected to the first heat exchanger.

10. The fuel cell system of claim 8, wherein the second heat exchanger includes a flow path through which the mixed fuel passes.

11. The fuel cell system of claim 10, wherein the nozzle is disposed toward a surface of the flow path.

12. The fuel cell system of claim 10, wherein the surface of the flow path is formed from a hydrophobic or water repellent surface process.

13. The fuel cell system of claim 10, wherein a film including a hydrophobic material is formed on the surface of the flow path.

14. The fuel cell system of claim 1, wherein the temperature of the second gas is lower than the temperature of the recovery unit.
